(19) United States
(12) Patent Application Publication
(10) Pub. No.: US 2025/0063117 A1
(43) Pub. Date: Feb. 20, 2025

(54) USER EQUIPMENT AND SYSTEM AND METHOD FOR HANDLING INCOMING CALLS

(71) Applicant: NAXOS FINANCE SA, Luxembouorg (LU)

(72) Inventor: Ana Flavia ASSIS DOURADO, Milan (IT)

(21) Appl. No.: 18/719,762

(22) PCT Filed: Dec. 15, 2021
(86) PCT No.: PCT/IB2021/061793

§ 371 Date: Jun. 13, 2024

(51) Int. Cl. H04M 3/42

(52) U.S. Cl. CPC H04M 3/42365; H04M 2203/2011

(57) ABSTRACT

The invention relates to a user system comprising a user equipment and a communication device, wherein said user equipment is configured for receiving phone calls and possibly also a muting signal generated by the communication device, and/or a method for handling an incoming phone call received by said user equipment, wherein said method comprises a reception phase, in which the muting signal generated by the communication device is received via reception means, wherein said muting signal comprises availability data specifying if said communication device is being used for carrying out a non-interruptible or non-disturbable activity, and a management phase, in which it is determined by processing and/or control means, on the basis of said availability data, whether said phone call should be muted and/or forwarded.

### BACKGROUND OF THE INVENTION

### 1. The Field of the Invention

The present invention relates to a user equipment and system and to a method for handling an incoming call received by said user equipment (whether a traditional phone call or a VoIP call): in particular, for handling an incoming video call and/or voice call when the called party cannot, or is not in the best condition to, answer said call.

### 2. The Relevant Technology

Within the frame of the present invention, therefore, the term “phone call” should be understood as a call generally received by a mobile phone over the common telephone network (3G, 4G, 5G, etc.) or through the Internet via a VoIP system, typically using applications such as “WhatsApp”, “Telegram”, etc.

As is known, due to the current wide diffusion of pathogenic elements, such as, for example, the SARS-CoV-2 virus, many working and/or educational activities are no longer carried out on site, but via teleconference systems from the worker's office or the student's home, so as to reduce the risk of contagion.

Because of this, many processes (decision-making, learning, etc.) that previously took place only on working or educational premises (offices, factories, schools, universities, research centres, or the like) are now carried out simultaneously in a plurality of distinct locations, i.e. at the offices/homes of the people involved: every day, in fact, such people participate in lessons, professional training courses, work meetings, etc. over the Internet, while remaining on their own working/living premises.

These activities, which may even take place in a language other than the mother tongue of the people involved, require much concentration from the latter, who, not being immersed in the same working or learning context (e.g. a meeting room, a classroom, a lecture room, or the like) may more easily lose track of what is happening during one or more of such activities over the Internet: for example, when a person is at home, he/she is more likely to be disturbed by a call received by his/her smartphone, because in such a situation people usually do not (whether intentionally or not) disable/mute incoming calls, not being conditioned by being assembled with other people in a common location, which would be a more austere context than a person's home.

European patent publication no. EP 1 678 930 B1 in the name of AMERICA ONLINE INC. provides a solution to this problem, but its implementation requires an adequate telephone structure, so that this solution is hardly usable by most people.

### SUMMARY OF THE INVENTION

The present invention aims at solving these and other problems by providing a method for handling an incoming phone call received by a user equipment.

Moreover, the present invention aims at solving these and other problems by providing also an innovative user equipment and/or system.

The basic idea of the present invention is to configure a user system comprising a user equipment (e.g. a smartphone, a PC, an IP phone, or the like) capable of receiving phone calls (whether traditional or VoIP phone calls) in a manner such that it may possibly receive a muting signal generated by a communication device included in the system (such as a personal computer, a tablet, or the like) and comprising availability data specifying if said device is currently in a situation in which an activity is going on which cannot be interrupted or disturbed (e.g. a remote learning session). If this is the case, the muting signal will prevent the call-receiving equipment from ringing, possibly also forwarding the incoming call to a voicemail service.

This will avoid that a person, who may be engaged in a non-interruptible activity, might be disturbed by a call to his/her call-receiving user equipment, and will make it possible to handle said call correctly (e.g. by forwarding it to a voicemail service, an assistant, etc.), so that the person who has received the call will be able to know the reason for the call as soon as the non-interruptible activity is completed. It is thus possible to reduce the probability that the person might be distracted and/or disturbed during his/her activity, while at the same time avoiding that he/she might ruin his/her social relationships, e.g. by not answering the call or by answering briefly and unkindly.

Further advantageous features of the present invention will be set out in the appended claims.

### BRIEF DESCRIPTION OF THE DRAWINGS

These features as well as further advantages of the present invention will become more apparent in the light of the following description of a preferred embodiment thereof as shown in the annexed drawings, which are provided merely by way of non-limiting example, wherein:

FIG. 1 shows a block diagram of a user system comprising a user equipment for receiving phone calls according to the invention and a communication device;

FIG. 2 shows a system for handling incoming calls, which comprises the user equipment of FIG. 1:

FIG. 3 shows a flow chart representing the phases of a method for handling an incoming phone call received by a user equipment according to the invention.

### DETAILED DESCRIPTION OF THE PREFERRED EMBODIMENTS

In this description, any reference to “an embodiment” will indicate that a particular configuration, structure or feature is comprised in at least one embodiment of the invention. Therefore, expressions such as “in an embodiment” and the like, which may be found in different parts of this description, will not necessarily refer to the same embodiment. Moreover, any particular configuration, structure or feature may be combined as deemed appropriate in one or more embodiments. The references below are therefore used only for simplicity's sake, and shall not limit the protection scope or extension of the various embodiments.

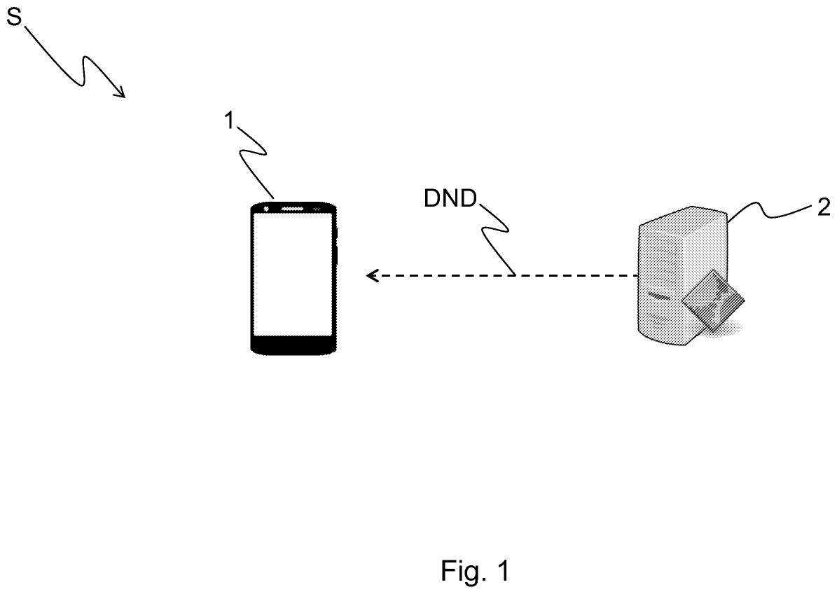

With reference to FIG. 1, a user system S for handling incoming calls comprises the following elements:
a user equipment 1 for receiving phone calls according to the invention;
a communication device 2 (e.g. a PC, a laptop, a tablet, or the like), which can be used for carrying out said non-interruptible or non-disturbable activity, such as, for example, a remote learning session, a video conference, or the like.

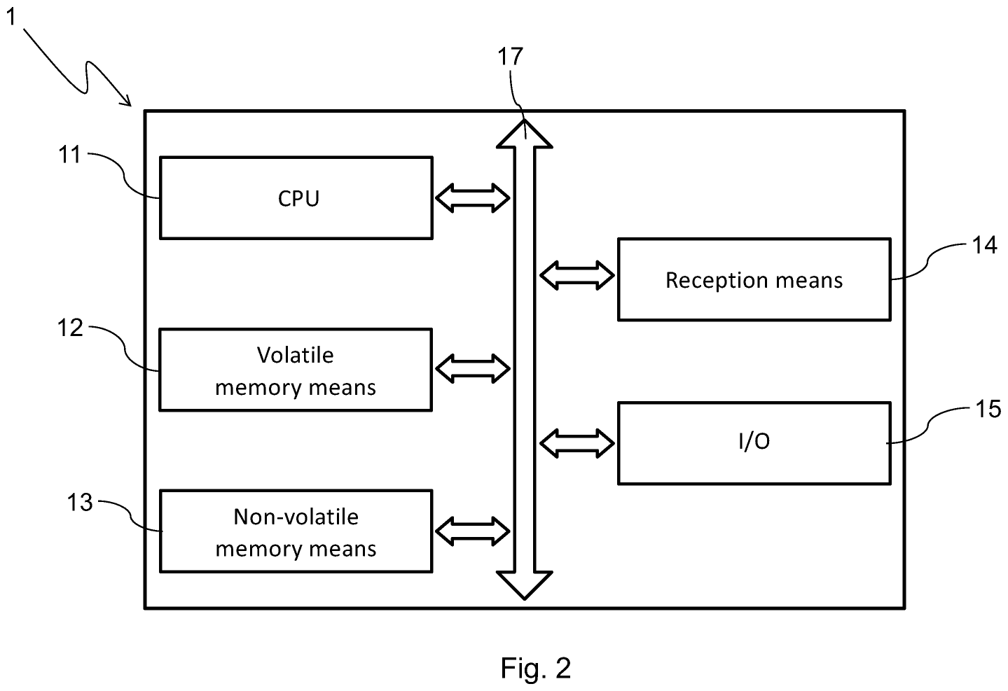

Also with reference to FIG. 2, an embodiment of the user equipment 1 for receiving phone calls (e.g. a smartphone, a smartwatch, an IP phone, or the like) according to the invention comprises the following components:
processing and/or control means 11, e.g. one or more CPUs, which govern the operation of the user equipment 1, preferably in a programmable manner, through the execution of suitable instructions;
volatile memory means 12, e.g. a random access memory RAM, in signal communication with the processing and/or control means 11, wherein said volatile memory means 12 contain at least instructions that can be read by the processing and/or control means 11 when the user equipment 1 is in an operating condition;
non-volatile memory means 13, preferably a Flash memory of the like, in signal communication with the processing and/or control means 11 and with the volatile memory means 12, wherein said memory means 13 store a set of instructions implementing, among other things, a method for handling an incoming phone call received by said user equipment 1 according to the invention;
reception means 14 configured for receiving a muting signal DND (DO NOT DISTURB) generated by a communication device 2, wherein said signal comprises availability data specifying if said communication device 2 is being used for carrying out said non-interruptible or non-disturbable activity: such reception means will be described in more detail hereinafter;
input/output means (I/O) 15, which can be used, for example, for connecting to said user equipment 1 a number of peripherals (e.g. one or more interfaces allowing access to other storage means, so as to permit, for example, copying information from the latter to the non-volatile memory means 13) or a programming terminal configured for writing instructions (which the processing and/or control means 11 will have to execute) into the memory means 12, 13; such input/output means 14 may comprise, for example, a USB, FireWire, RS232, IEEE 1284, etc. adapter;
a communication bus 17 allowing information to be exchanged among the processing and/or control means 11, the volatile memory means 12, the non-volatile memory means 13, the reception means 14 and the input/output means 15.

As an alternative to the communication bus 17, the processing and/or control means 11, the volatile memory means 12, the non-volatile memory means 13, the reception means 14 and the input/output means 15 may be connected by means of a star architecture.

In the main embodiment, the reception means 14 preferably comprise a 802.11 (also known as WiFi), 802.16 (also known as WiMax) or 802.15 (also known as Bluetooth) network interface or a GSM/GPRS/UMTS/LTE or TETRA data network interface, or the like, which allow the user equipment 1 to communicate with the communication device 2 over a data network. In other words, the reception means 14 preferably comprise a radio receiver.

With a similar architecture, the communication device 2 comprises processing means (e.g. a CPU) and transmission means in communication with said processing means, wherein said transmission means preferably comprise a radio transmitter (e.g. a 802.11, 802.16 or 802.15 network interface or a GSM/GPRS/UMTS/LTE or TETRA data network interface, or the like), wherein said processing means are configured for executing the following steps:
detecting if a non-interruptible activity is being carried out by using said communication device 2, e.g. by acquiring a list of audio and/or video processes in execution in said device and comparing said list with a second list containing identification data identifying those processes through which non-interruptible activities are normally carried out (e.g. video/audio conference applications, remote learning applications, etc.), or by acquiring, by means of a microphone, an audio signal representing sounds that can be heard within the environment surrounding said communication device 2, or by reading the data of an electronic calendar, or the like;
generating availability data (e.g. a bit packet having a predefined logic value) if said non-interruptible (non-disturbable) activity is detected;
transmitting, via the transmission means, a signal comprising said availability data.

As concerns how the communication device 2 reveals that it is executing an audio/video communication that should not be interrupted or disturbed, it must be pointed out that it is possible to detect if one or more applications have been installed in the communication device 2 which can handle video and/or audio conferences, such as Webex, Teams, BlueJeans, Zoom, Skype, etc. In a database of such applications at least one operating state thereof is recorded, in particular which system resources such applications are having access to. When such applications are running on the computer and request the processing and/or control means 11 to grant access to the camera and/or the microphone associated with the communication device 2, i.e. when they are in an operating situation in which a video/audio call is in progress which should not be interrupted or disturbed, such situation will be detected and recorded into the database. In other words, the communication device preferably comprises a camera and/or a microphone, and said communication device 2 may also be configured for detecting that said non-interruptible or non-disturbable activity is in progress when said camera and/or said microphone are being used by an application in execution on said communication device.

This makes it unnecessary to modify the video and/or audio conference applications in order to implement the invention. It is thus possible to reduce the probability that the person might be distracted and, advantageously, that he/she might ruin his/her social relationships with other people.

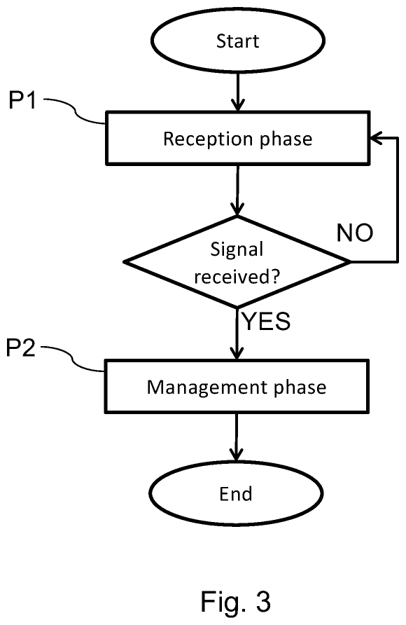

Also with reference to FIG. 3, when the user equipment 1 is in an operating condition, the processing and/or control means 11 are configured for executing the following phases of the method according to the invention:
a reception phase P1, in which the muting signal DND generated by a communication device 2 is received via said reception means 14, wherein said signal DND comprises availability data specifying if said communication device 2 is being used for carrying out said non-interruptible or non-disturbable activity, such as, for example, a remote learning session, a video/audio conference, a medical examination, a remote surgical operation, or the like;
a management phase P2, in which it is determined, on the basis of said availability data, whether said phone call should be muted and/or forwarded to another person (e.g. a professional collaborator, a relative, a neighbour, etc.) or to a voicemail service, if the recipient of said call is participating in an Internet conference or the like.

This will avoid that a person engaged in a non-interruptible activity might be disturbed by a call to his/her call-receiving user equipment 1, and will make it possible to handle said call correctly (e.g. by forwarding it to a voicemail service, an assistant, etc.), so that the person will be able to know the reason for the call as soon as the non-interruptible or non-disturbable activity is completed. It is thus possible to reduce the probability that the person might be distracted, while at the same time avoiding that he/she might ruin his/her social relationships with other people.

Of course, the example described so far may be subject to many variations.

A first variant comprises a call-receiving user equipment that is similar to the above-described user equipment 1, wherein the reception means for receiving a signal DND of said user equipment 1 comprise an optical receiver, e.g. a camera, configured to detect an optical signal emitted by a device similar to the above-described communication device 2, whose transmission means contain video signals (e.g. a screen connected to a video adapter comprised in said communication device 2), wherein such video reproduction means are configured to emit/transmit the video signal when said communication device 2 is being used for carrying out said non-interruptible or non-disturbable activity.

This embodiment turns out to be of particular interest because, when video conference or remote learning software applications are in use, the screens of the people connected to the same Internet session will typically display the same video stream, wherein the reproduction of such video stream on a screen can generate said (optical) signal in the environment surrounding the screen of said communication device 2.

An exemplary optical signal may be generated by a sequence of colour images that are reproduced in succession on an additional screen, or by images alternating at a given frequency (intermittence), thus generating a blinking effect in the environment around the screen, preferably at a frequency that can be detected by a camera of the user equipment 1, but not by the human visual apparatus (thus not disturbing the user): such an optical signal can be easily detected by said optical receiver, while the availability data are decoded by the processing and/or control means of the user equipment 1, e.g. by executing a sequence of instructions implementing a neural network trained to decode said availability data upon reception of a video stream generated by the camera (optical receiver).

Advantageously, this variant simplifies the use of the invention, because it does not require the user equipment 1 and the communication device 2 to be paired before use, unlike the embodiment which, using a WiFi and/or Bluetooth network, requires the execution of a pairing procedure between the user equipment 1 and the communication device 2 before use. This makes this embodiment of the invention particularly suitable for use in environments where non-interruptible or non-disturbable activities are carried out and where there is a constant rotation of personnel who cannot take the liberty of being distracted by, or wasting time for, the pairing procedure, as is the case, for example, in an operating room, a crane control cabin, a heavy vehicle, an aircraft, or the like.

This will avoid that a person engaged in a non-interruptible activity might be disturbed by a call to his/her call-receiving user equipment, and will make it possible to handle said call correctly (e.g. by forwarding said call to a voicemail service, an assistant, etc.), so that the person will be able to know the reason for the call as soon as the non-interruptible or non-disturbable activity is completed. It is thus possible to reduce the probability that the person might be distracted, while at the same time avoiding that he/she might ruin his/her social relationships with other people.

A second variant comprises a user equipment similar to the user equipment 1 of the main embodiment, wherein the reception means of said user equipment comprise an audio receiver, e.g. a microphone, configured to detect an (audio) signal emitted by a device similar to the above-described communication device 2 and comprising audio reproduction means (e.g. at least one loudspeaker connected to an audio output comprised in said device), wherein the audio reproduction means are configured to emit/transmit the signal when said device is being used for carrying out said non-interruptible activity.

Also this embodiment turns out to be of particular interest because, when video/audio conference or remote learning software applications are in use, the audio reproduction systems comprised in the devices of the people connected to the same Internet session will typically play the same audio stream, wherein the reproduction of such audio stream generates said (audio) signal in the environment surrounding said communication device 2.

An exemplary audio signal may be generated by a sound having a predefined frequency, preferably a frequency that can be detected by a microphone (preferably a piezoelectric one), but not by the human hearing apparatus (thus not disturbing the user): such audio signal can be easily detected by the microphone associated with said user equipment 1, while the availability data are decoded by the processing and/or control means of the user equipment, e.g. by executing a sequence of instructions implementing a neural network trained to decode said availability data upon reception of an audio stream, preferably generated by an analogue-to-digital converter comprised in the device and connected to said microphone (audio sensor).

Also this variant advantageously simplifies the use of the invention, because it does not require the user equipment 1 and the communication device 2 to be paired before use.

This will avoid that a person engaged in a non-interruptible activity might be disturbed by a call to his/her call-receiving user equipment, and will make it possible to handle said call correctly (e.g. by forwarding said call to a voicemail service, an assistant, etc.), so that the person will be able to know the reason for the call as soon as the non-interruptible or non-disturbable activity is completed. It is thus possible to reduce the probability that the person might be distracted, while at the same time avoiding that he/she might ruin his/her social relationships with other people.

A third possible variant comprises a user equipment similar to the user equipment 1 of the main embodiment, wherein the reception means of said user equipment comprise a combination of two or more elements, which comprise a radio receiver and/or an optical receiver and/or an audio receiver.

In this manner, the benefits of all embodiments are combined together, so as to advantageously increase the noise immunity of the whole user system for handling incoming phone calls.

Some of the possible variants have been described above, but it will be clear to those skilled in the art that other embodiments may also be implemented in practice, wherein several elements may be replaced with other technically equivalent elements.

For example, a command may be made available to the user on both the user equipment 1 and the communication device 2 for, respectively:
ignoring the arrival of the muting signal (DND), on the reception side,
or creating and sending it, on the transmission side.

In other words, when an inhibition situation occurs, e.g. caused by the execution of an inhibition command through an application or upon reception of a phone call from a particular predefined number (e.g. a number of a close relative), or the like, said processing and/or control means 11 of the user equipment 1 may also be configured for ignoring the reception of the muting signal DND that comprises said availability data. As an alternative or in combination, when said inhibition situation occurs said processing means of said communication device 2 may be configured for inhibiting the generation of the availability data or the transmission of the muting signal DND.

This will prevent a person engaged in a non-interruptible activity from losing contact with the surrounding reality. It is thus still possible to reduce the probability that the person might be distracted in vain, while nevertheless avoiding that the person might ruin his/her social relationships with other people.

The present invention is not therefore limited to the illustrative examples described herein, but may be subject to many modifications, improvements or replacements of equivalent parts and elements without however departing from the basic inventive idea, as specified in the following claims.

1.-13. (canceled)

14. A user system for handling incoming calls, comprising:
a user equipment and a communication device, wherein said user equipment comprises:
processing and/or control means configured for handling an incoming call received by said user equipment; and
reception means configured for receiving a muting signal generated by the communication device:
wherein the communication device comprises:
transmission means for transmitting said muting signal; and
processing means configured for:
detecting if a non-interruptible or non-disturbable activity is being carried out by using said communication device:
generating availability data if said non-interruptible or non-disturbable activity is detected, wherein said availability data specify if said communication device is being used for carrying out said non-interruptible or non-disturbable activity:
transmitting, via the transmission means, the muting signal comprising said availability data,
and wherein said processing and/or control means of the user equipment are also configured for determining, on the basis of said availability data, whether said incoming call should be muted and/or forwarded.

15. The user system according to claim 14, wherein the reception means of the user equipment comprise a radio receiver, and wherein the transmission means of the communication device comprise a radio transmitter.

16. The user system according to claim 14, wherein the reception means of the user equipment comprise an optical receiver, and wherein the transmission means of the communication device comprise video reproduction means.

17. The user system according to claim 14, wherein the reception means comprise an audio receiver, and wherein the transmission means of the communication device comprise audio reproduction means.

18. The user system according to claim 14, wherein said communication device comprises a camera and/or a microphone, and wherein said communication device is also configured for detecting that said non-interruptible or non-disturbable activity is in progress when said camera and/or said microphone are in an operating condition.

19. The user system according to claim 14, wherein, when an inhibition situation occurs,
said processing and/or control means of the user equipment are also configured for ignoring the reception of the muting signal that comprise said availability data; and/or
said processing means of said communication device are configured for inhibiting the generation of the availability data or the transmission of the muting signal.

20. A method for handling an incoming call received by a user equipment, comprising:
a reception phase, in which a muting signal generated by a communication device is received via reception means, wherein said muting signal comprises availability data specifying if said communication device is being used for carrying out a non-interruptible or non-disturbable activity; and
a management phase, in which it is determined by processing and/or control means, on the basis of availability data, whether said incoming call should be muted and/or forwarded.

21. The method according to claim 20, wherein said muting signal is a radio signal.

22. The method according to claim 20, wherein said muting signal is an optical signal.

23. The method according to claim 20, wherein said muting signal is an audio signal.

24. The method according to claim 20, wherein, during the reception phase, the reception of the muting signal is inhibited when an inhibition situation occurs.

25. A computer program product which can be loaded into a memory of an electronic computer comprising reception means, wherein said memory comprises a portion of software code for executing the phases of the method according to claim 20.

26. A user equipment configured for executing the phases of the method according to claim 20.
